(19) United States
(12) Patent Application Publication
(10) Pub. No.: US 2014/0143763 A1
(43) Pub. Date: May 22, 2014

(54) Method and System to develop operating system agnostic software applications for mobile devices using a virtual machine

(71) Applicant: Harsh Bhargava, Sunnyvale, CA (US)

(72) Inventor: Harsh Bhargava, Sunnyvale, CA (US)

(21) Appl. No.: 13/970,458

(22) Filed: Aug. 19, 2013

Related U.S. Application Data
(60) Provisional application No. 61/719,557, filed on Oct. 29, 2012.

(51) Int. Cl. G06F 9/45

(52) U.S. Cl. CPC G06F 8/40
USPC 717/139

(57) ABSTRACT

A system and method of developing software applications for mobile devices that (a) allows the application to be written once using a high-level application definition language and (b) deploys on devices running different operating systems (OS). The application definition language is agnostic to the operating system and that has constructs to define the complete application including its user interface, data sources, events and actions and business logic. The application definition language is interpreted by the App Virtual Machine at run-time and native Application Programming Interfaces (APIs) are called to create the user interface, display the data from different data sources and execute actions when events occur. The method aims to (a) increase the productivity of the app writers (b) reduce time and cost to develop such software programs for multiple operating systems (c) reduce the amount of source code needed to write an application.

### CROSS-REFERENCE TO RELATED APPLICATIONS

This application is based on and claims priority under 35 USC 119 (e) from USPTO Provisional Application No. 61/719,557 filed on Oct. 29, 2012.

### BACKGROUND

Software applications (or apps) targeted for mobile devices including smart phones and tablet computers are written using a Software Development Kit (SDK) provided by the manufacturers of their operating system 15. If the application were to be written that run on other operating system 15, the source code needs to be rewritten or ported to the intended operating system 15 which may have a different language and Application Programming Interfaces (APIs) 17.

The methodology of writing apps in their native software development kits results in having multiple streams of source code that needs to be synchronized with every change requests or addition of new features. If the app publisher were to support four operating systems 15, then the app has to be written in four different languages. Writing software programs in different languages and using different Application Programming Interfaces (targeted for different operating systems 15) results in increased time and cost of developing software programs and maintaining them all these platforms.

There is a need for new methods for developing software applications for mobile devices (smart phones and tablet computers) that addresses the issues discussed above. The new method needs to provide a way to define the application using a language that is agnostic to the operating system 15 and its APIs and that includes constructs to define User Interface 11, Data Sourcing methods and workflow of a software program (or application or app). Then it can be deployed on different operating systems 15 that run the mobile devices smart phones and tablet computers. The method needs to provide a way to develop software programs without the need of an in-depth programming knowledge required by individual operating system(s) 15. The method needs to provide a way to include rich and complex user interface controls (for example, charts) or commonly used features and functions (for example Push Notifications, In App Purchases, Location Services). These features can be written by third party vendors as well and the app writer can just include these components to get the functionality.

### BRIEF SUMMARY

In one or more embodiments of this invention, an application writer will be able to write a native mobile app once with single source code base to run on multiple operating systems 15. This is accomplished by introducing an application definition language that is agnostic to operating system 15 and their Application Programming Interfaces (APIs) and that can be interpreted at run-time by an App Virtual Machine 10 at run time. The App Virtual Machine 10 reads the application definition and calls operating systems 15 specific Application Programming Interface (APIs) 17.

As part of this invention, an application definition language is created for developing mobile apps that is agnostic to the differences in language and APIs of different operating system 15. The language has constructs to (a) layout a user interface (UI) by positioning controls on a screen and defining their appearance (b) define data sources for screens 21 and controls 22 to populate the UI with data fetched from local device or from internet (c) define and associate actions with the events including but not limited to user gestures like tap, flick (d) define business logic and attach it to validate and transform data or drive mobile app UI navigation.

As part of this invention, an App Virtual Machine 10 is created that uses native APIs of an operating system 15 to perform following tasks (a) Interpret the User Interface 11 definition of the app at run time and create it on the device's screen 31 (b) Interpret the data sourcing definition and call data sources to populate the data in the screen 31 and controls 22. The data can be fetched data from local device or remote server. (c). Invoke the action or call a business logic 14 function when the event to which they are associated with occurs. Each operating system 15 will have its App Virtual Machine 10 written in native Software Development Kit (SDK) language and uses native APIs to perform its tasks listed above.

The application definitions and the App Virtual Machine 10 are bundled into the mobile app's executable which can be distributed to app users who can install the app on their mobile devices.

### BRIEF DESCRIPTION OF THE DRAWINGS

FIG. 1 depicts a block diagram of how native mobile applications are developed prior to this invention. The block diagram depicts two different operating systems that run different mobile devices. Each operating system has a different language to call native API's. It also depicts two separate versions of mobile application written in two different languages calling the respective native APIs to (a) create the user interface 11, (b) call data sources 12 to populate the data on the UI 11, (c) invoke actions 13 when the operating system 15 raises corresponding events and (d) invoke business logic 14 functions wherever needed.

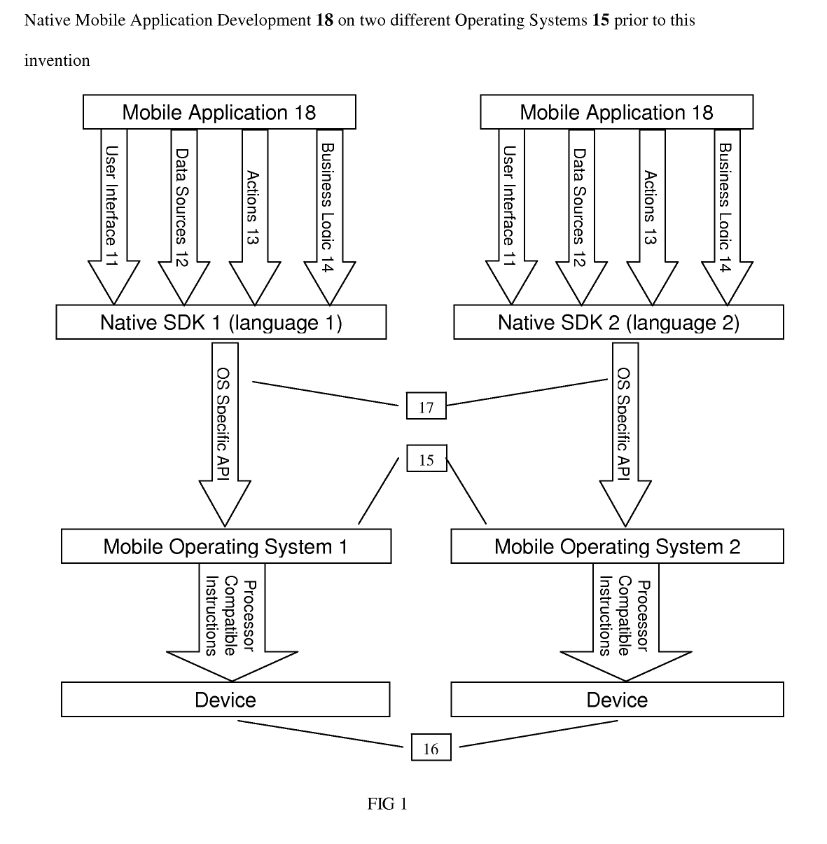

FIG. 2 depicts a block diagram and is a preferred embodiment of this present invention wherein two mobile devices 16 that are run by two different operating systems 15 run a mobile application that is created out of the same code base. At the bottom of the block diagram is a mobile device which is controlled by the operating system 15. The mobile app at the top is developed using a common application definition language. The mobile app's executable is created by bundling the common app definition and the App Virtual Machine 10. This executable is then installed on top of the operating system 15. Upon running the mobile app, the App Virtual Machine 10 reads the application definition and calls the operating system's 15 native Application Programming Interfaces 17 (APIs) to (a) create the user interface 11 (UI) elements, (b) invokes event handlers or Actions 13 when events are received from the underlying operating system 15 (c) raises its own events which provides as hooks for the application writer to call more actions 13 or business logic 14 functions. As shown in the diagram, each operating system 15 will need an App Virtual Machine that is written using its native SDK and call the relevant APIs.

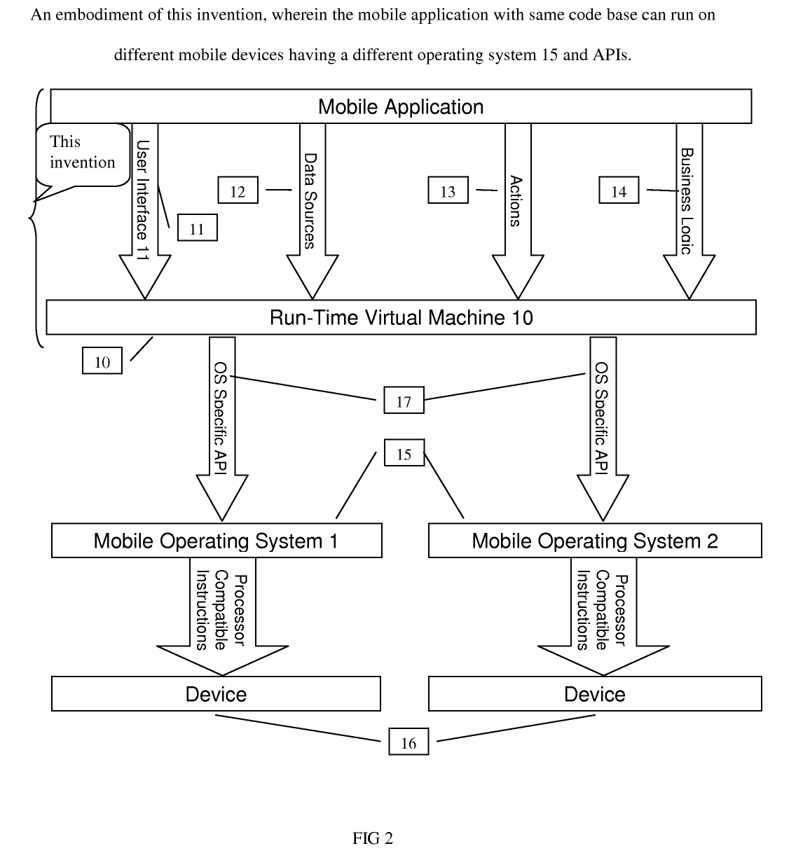

FIG. 3 depicts the picture of the screen 31 on a smart phone. A screen typically consists of a title and a body. Title and Body can have one or more controls 22.

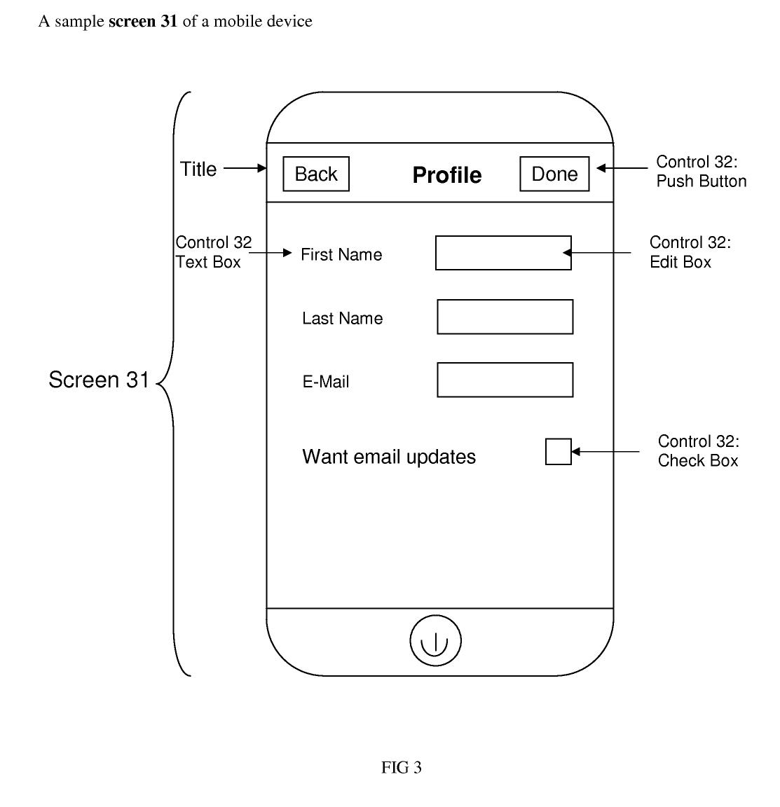

FIG. 4 shows the common application definition code to create the screen in FIG. 3. The code is written in eXtensible Markup Language (XML). Lines 1-40 define the screen attributes and its child controls for the screen shown in FIG. 3. Lines 101-114 define the appearances used with the controls.

FIG. 5 shows a sample list of screen 31 attributes. The screen 31 attributes are defined by the application writer. They are used to define the physical appearance of the screen 31, dimension of the screen 31 (x, y, width, height), initial layout (PORTRAIT, LANDSCAPE), allowed orientations (PORTRAIT only, LANDSCAPE only, BOTH). The attribute name identifies the screen 31 with a unique name that is used in action NEXT_SCREEN's attribute called “target”.

FIG. 6 shows a sample list of control 32 attributes using which a control 32 can be defined. A screen 31 contains one or more user interface 11 elements called controls 22. The App Virtual Machine 10 will call the operating system 15 specific APIs to (a) create the controls 22 (b) set up event listeners (c) give the visual appearance to the control 32 (d) set the data or read the data from the controls.

FIG. 7 shows a sample list of appearance attributes. Appearance defines the physical looks of the control 32. The physical appearance includes font name, font color, font size, background color. It also contains border width, border color and border radii. Application writer can use the appearance to make the user interface 11 look neat and pretty.

FIG. 8 shows a sample list of attributes related to data sourcing for screen 31 and control 32. Data sourcing is a very important aspect of application definition without which the application cannot exist. Data sourcing attributes either define a local data source or a remote data source. A local data source fetches data from the local device itself. The local data source can be including but not limited to a Structure Query Language (SQL), can be an image (including but not limited to JPEG, GIF, TIFF), audio or video resources, XML (Extensible Markup Language), JavaScript Object Notation (JSON) or Comma Separated Values (CSV). When the remote data source is defined the data is fetched from the internet using the internet protocol (IP). The remote data format can any text file including but not limited to JSON, XML, CSV, any image file format including but not limited to JPEG, GIF, TIFF.

FIG. 9 depicts a sample list of pre-defined actions 13 in the action system. In a mobile device, the operating system 15 generates events upon various user gestures including but not limited to tap, flick or long tap. Actions 13 are also called event handlers. Actions 13 are invoked upon the occurrence of the event to which they are associated with. Application writer uses actions 13 to drive the application behavior. Common actions 13 are including but not limited to calling the “next screen 31”, “calling another application” on the mobile device, “closing the current screen 31”, “calling a custom function” that specifies the business logic 14.

FIG. 10 depicts a sample list of events generated by App Virtual Machine 10. The App Virtual Machine 10 generated events are additional hooks for the application writer to specify business logic. These types of events make the App Virtual Machine have similar behavior on different operating system 15 from different competing vendors. It helps in making the app work similar though the underlying operating system 15 is different.

FIG. 11 shows a sample configuration file. Configuration files define the attributes and their types for screens 21, controls 22 and actions 13. The App Virtual Machine 10 gets the definition of application components from the configuration files. The application definition language (FIG. 4) can only use those components that are defined in the configuration files. The sample configuration file in FIG. 11 defines a new control 32 type called “CHART”. The lines 5-35 define the permitted attributes of a control 32. The attributes can have constraints. For example, the constraint “type” denotes the kind of values the control can take. If the type is a “enum”, the attribute can take a value from a pre-defined set of values, otherwise the application definition file is marked erroneous. The line 36, defines the new control “CHART”. Any number of configuration files can be given to the App Virtual Machine 10 and that makes the App Virtual Machine 10 extendible to include any number of application components (screens 21, controls 22 and actions 13).

### DETAILED DESCRIPTION AND BEST MODE OF IMPLEMENTATION

The principle objective of the present invention is to define a system and methodology that allows an application writer to code the app once and then run it on mobile operating systems 15 from different manufacturers. This is achieved by (a) Providing an application definition language to define the application namely user interface 11, data sourcing, events and action (b). Providing a virtual machine 10 to read, interpret and execute the application definition at run-time 10.

Application Definition—A mobile application is made up of at least 4 major components namely (a). User Interface 11 (UI) (b). Data Sources 12 to populate the UI 11. (c). Actions 13 (d). Business Logic 14. The application can be defined by (a) an app designer using easy high level declarative language in text files. (b) a WYSIWYG (What you see is What you get) editor that can store the create the application definition. The application definition language is a declarative language and the format can be including but not limited to Extensible Markup Language (XML), Comma Separated Values (CSV), or JavaScript Object Notation (JSON).

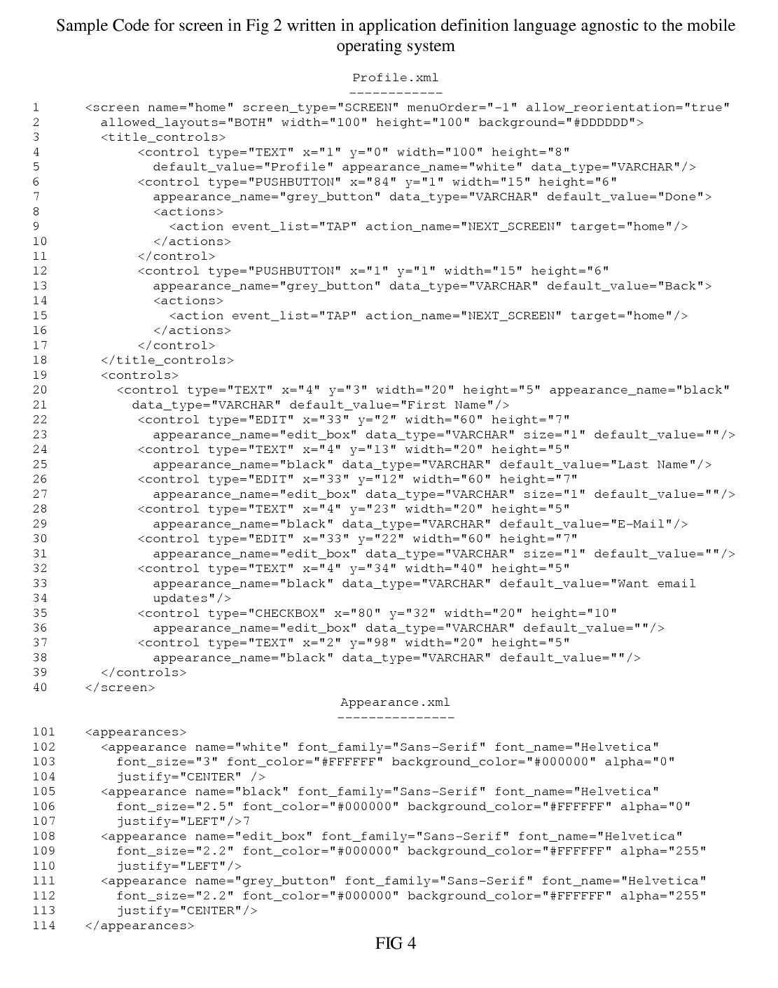

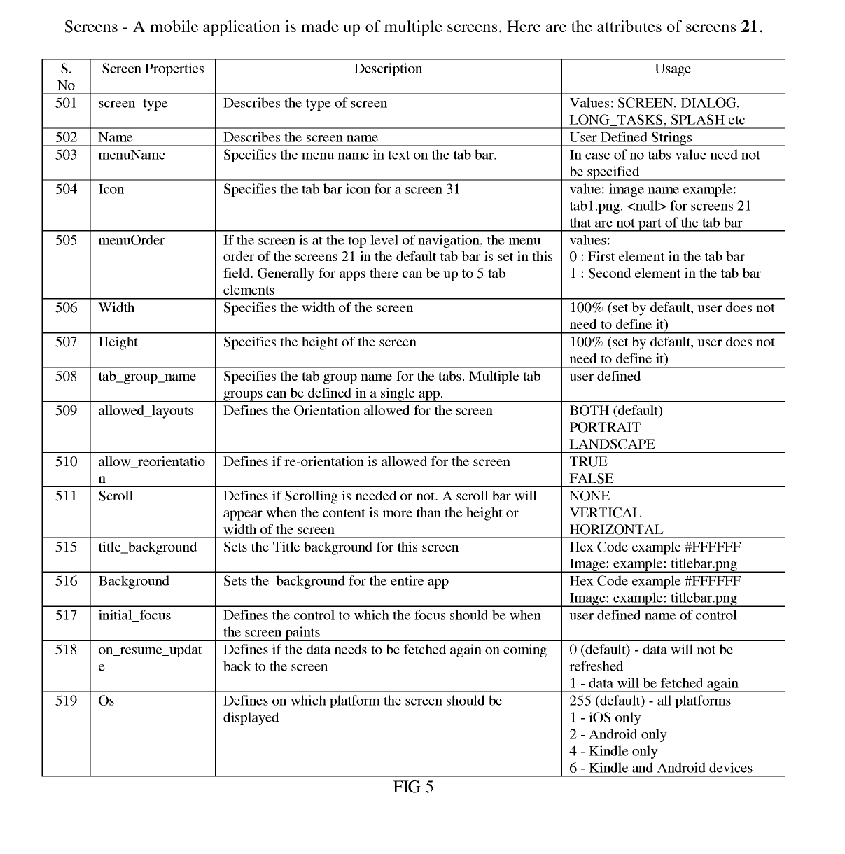

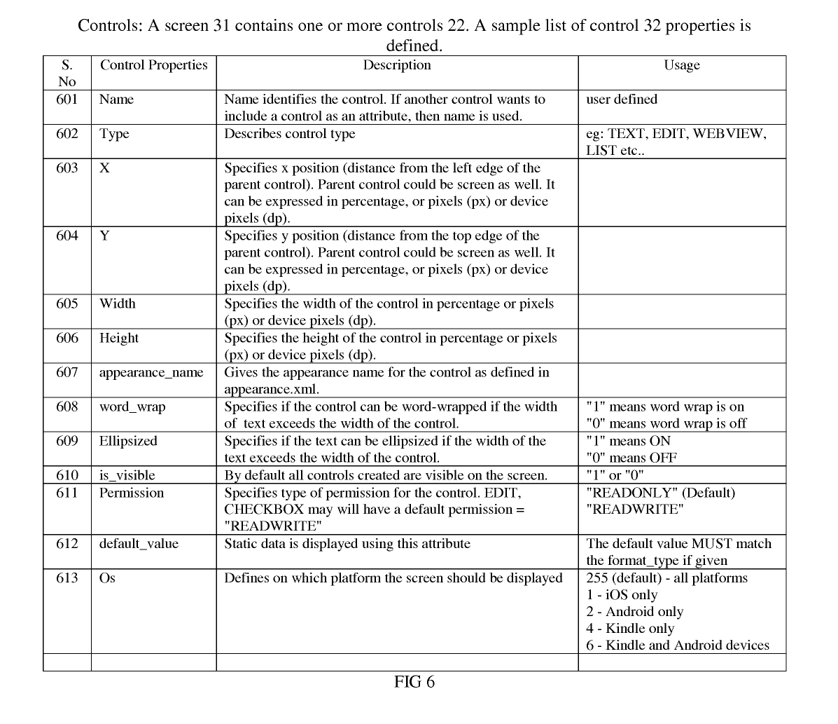

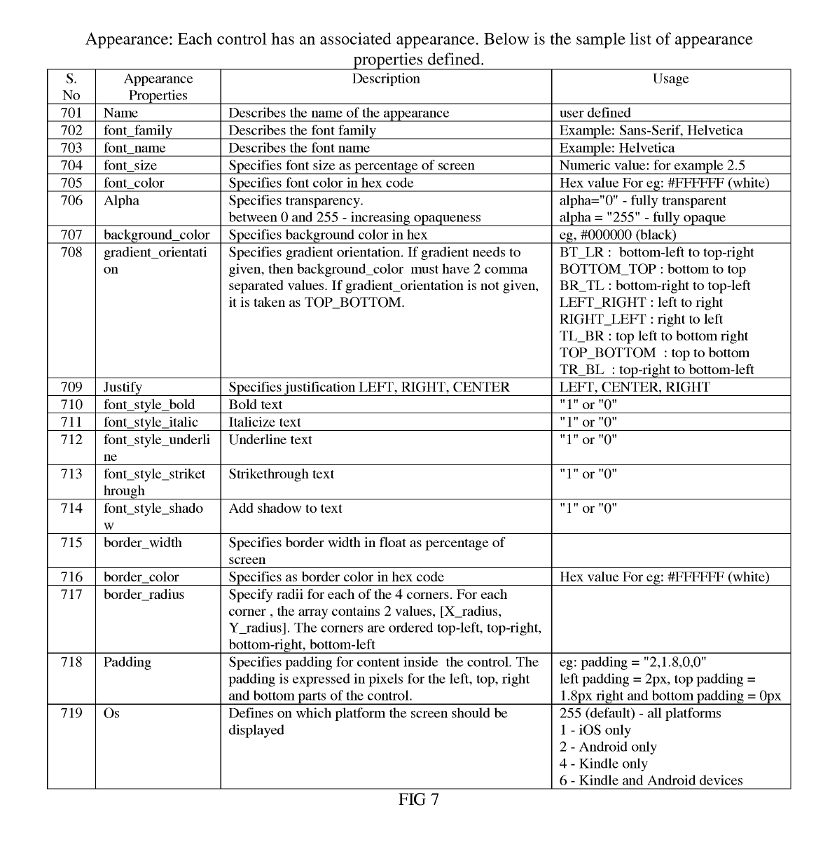

Application Definition: User Interface 11—The User Interface 11 is the layout of the application made up of one or more screens 21. A screen 21 contains one or more controls 22 in it. The application definition language contains constructs to define the screen and controls and specify values for their attributes. The screen 31 definition would typically contain attributes like title, icon, layout (PORTRAIT or LANDSCAPE) etc. Lines 1-2 of FIG. 4 show how the screen is defined. The sample list of screen 31 attributes is shown in FIG. 5 and can vary based on screen 31 type. The screen 31 contains one or more User Interface 11 elements called Controls 22 or Views. The application definition language contains constructs to define controls within a screen 31. Lines 19-39 show how the controls are defined within the body of the screen. Each UI 11 element will have attributes like position, appearance, default value etc. For example the attribute x, y, width and height will define where control 22 should be created on the screen 31. The size of the controls 22 can be defined in pixels or as a percentage of the screen 31 size. If defined as a percentage the absolute size of the controls 22 will vary with the size of the screen 31. The larger screen 31 tablet computers will show the same control 32 bigger as compared to the same control 32 on a smaller screen 31 phone. A sample list of attributes is defined in FIG. 6 and can significantly vary based on the control 32 type. The attributes can also vary based on the operating system 15 as well. Some attributes may be used by one operating system 15 and not by another one. The controls 22 or views either present the information on the screen 31 or take user input for example a text box will display the information and an edit field will take user input. The application designer can define application level attributes that are common to all screens 21 within the application. For example, if the same background is to be kept across all screens 21 then the background can be defined at the application level with the possibility of overriding at a screen 31 level. A control 32 can have more than one child controls 22 and is called a group control. This is especially needed for controls 22 like LIST where each list item can contain one or more controls 22. The visual look of the controls 22 is defined by an appearance. An appearance defines the background color, text color, font name, font size and other visual attributes. The sample list of appearance attributes can be found in FIG. 7.

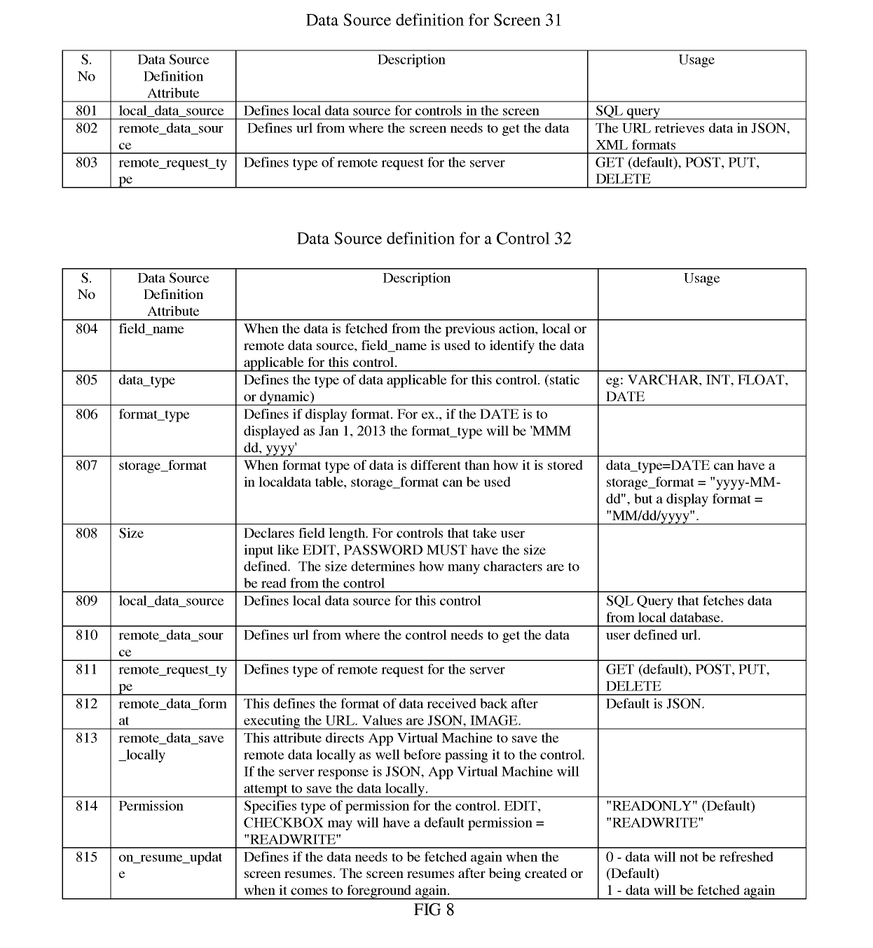

Application Definition: Data Sourcing 12—Another integral part of application definition is data sourcing 12. The data in an application is bidirectional—screen 31 can display the data or take inputs from the user. The data to be displayed can be fetched from a local database, local file on the device or remote database retrieved via Internet Protocol (IP). Similarly the data from the user inputs can be saved to the local database, local file on the device or to the remote server using Internet Protocol (IP). For displaying the data, the application writer can associate the data source with the screen 31 or with the control 32. The display data is fetched when the screen 31 or control 32 is first created or resumed. A screen 31 is said to be resumed when the screen 31 is first created or when it gets exposed as a result of another screen 31 on top of it getting closed. The sample list of attributes related to data sourcing is defined in the FIG. 8.

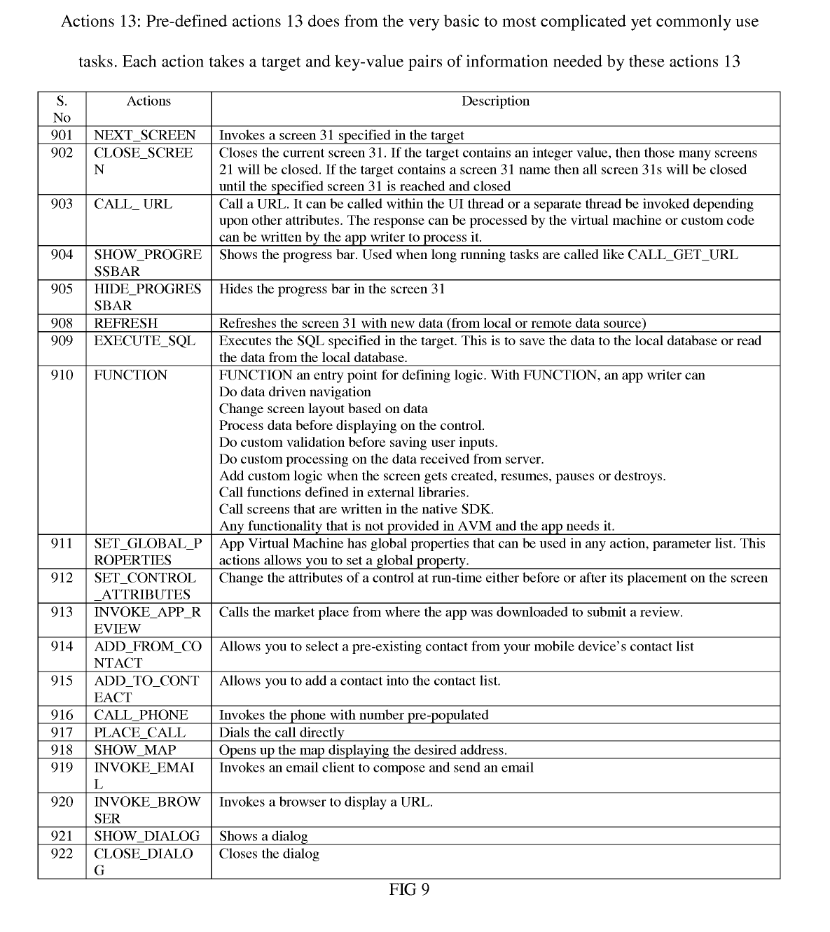

Application Definition: Actions 13—One of the embodiments of the present invention is the action system. The action system defined in the present invention improves the productivity of the application writer to a very large extent and reduces application development time drastically. The App Virtual Machine 10 provides the most commonly used actions 13 including but not limited to “go to next screen”, “close screen”, “refresh screen”, “invoke email” or “invoke browser” or “get GPS coordinates”. Lines 14-16 of FIG. 4 show how the action “NEXT_SCREEN” can be attached to the PUSH_BUTTON. The sample list of pre-defined actions 13 is listed in FIG. 9. Actions 13 are executed when events to which they are tied to are triggered.

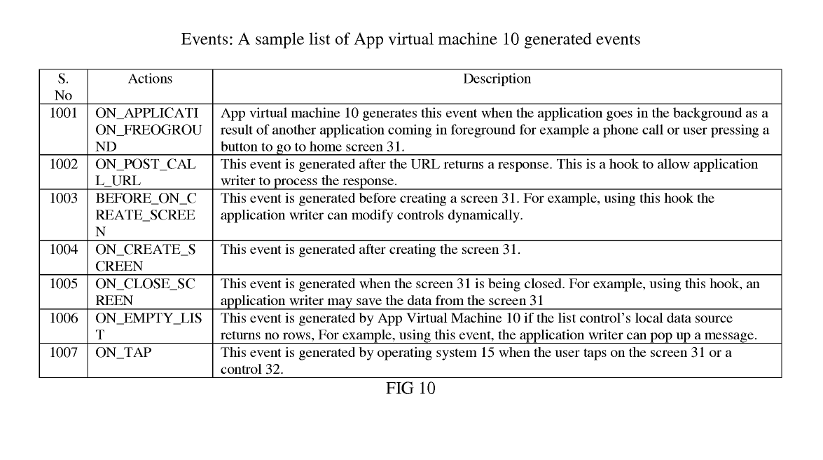

Application Definition: Events—Events occur (a) when the user does gestures like “tap”, “long tap”, “flick” or “two-flick” on the touch screen or (b) from application life cycle with events including but not limited to “on create screen”, “on pause screen”, “on close screen”, “on application foreground” or (c) from device sensors including but not limited to “on orientation change”, “on low battery”. Actions 13 are executed when the events to which they are attached to occur. Some events are generated by the operating system 15 while others can be generated by the App Virtual Machine 10. Line 15 of FIG. 4 shows that the action NEXT_SCREEN will be triggered on “TAP” to the PUSH_BUTTON. The sample list of events generated by the App Virtual Machine 10 is listed in FIG. 10.

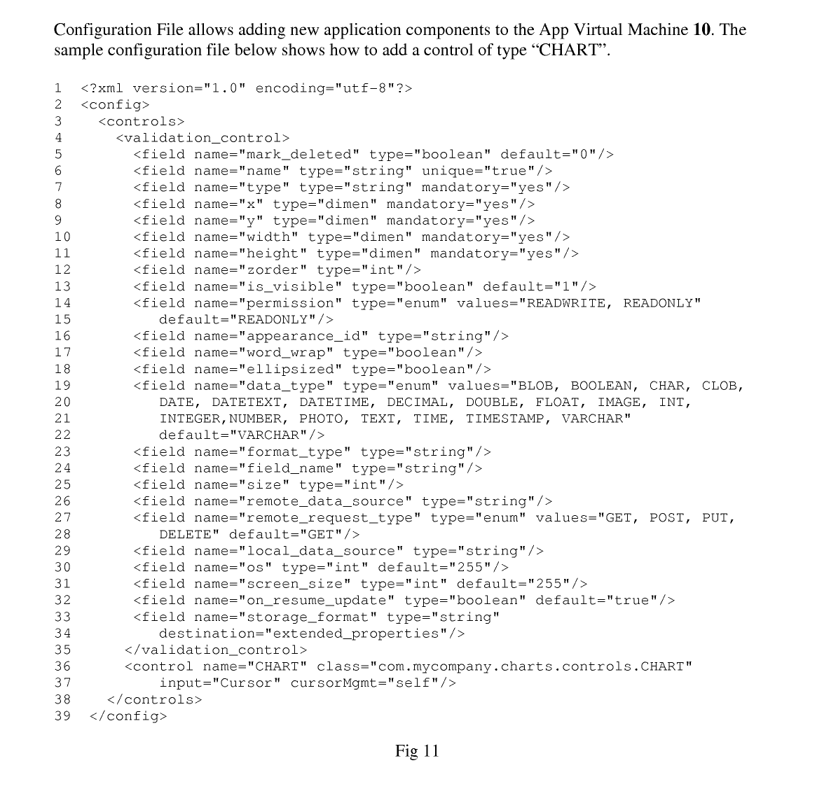

Extending functionality of the App Virtual Machine 10: The functionality of the App Virtual Machine 10 can be extended either (a) By adding new UI elements such as screens 21, controls 22, events and actions 13 or (b) By writing parts of the application in native SDK. Adding new application components—App developers can write new types of application components using native APIs and that gives a wide range of choices to the app writers to write applications faster and with richer user interface 11. The new application components are made known to the App Virtual Machine 10 using configuration files. A configuration file defines new types of screens 21, controls 22 and actions 13. See FIG. 11 for a sample configuration file. The method of writing a new application component is dependent upon the underlying operating system 15. A component could be a complex control like cover-flow or a complex feature like in app purchase, location services. An app can include any number of components. Another way of extending of the application is by writing part of application in native SDK—App writers can write custom functions in native SDK and the functions can be invoked using the action “FUNCTION”. From the custom function, app writer can invoke screens that are solely written in native SDK. This way App Virtual Machine allows the app writer to write any business logic 14 in native SDK or create a user interface that may not be part of the App Virtual Machine. Thus the app writers are not confined to use only those screen components that are pre-defined in the App Virtual Machine 10. They can define their own as well.

App Packaging—The virtual machine 10, along with the application definition files and supporting resources images, icons, sound files, video files are compiled into mobile Operating System (OS) 15 specific binaries. The OS specific binaries are then distributed and installed on the mobile device.

App Distribution—The app distribution may be done including but not limited to market places operated by various OS manufacturers, third party app distributers, via emails or other forms of app distribution.

### ADVANTAGES

Write Once—App virtual machine 10 allows applications to be written once and run on multiple platforms. This reduces time and effort spent on using multiple base lines of source code in different languages targeting various mobile operating systems 15.

Component Driven App Development—The method and system promotes writing high level components that can be easily integrated with the application. The examples of high level components (include but not limited to) are rich and complex User Interface controls like CoverFlow, ViewPager, Charts or widely used features like Push Notifications, In App Purchases and Location Services. These components may be provided by third parties. The app writer can download and integrate these components in their app resulting in further code reduction.

The combined effect of “Write Once” and “Component Driven Development” results in a code reduction up to 90%. Less code translates to faster time to market and a large reduction in total cost of ownership of an app.

Reduced Learning Curve—Another big advantage of the run-time virtual environment is the learning curve to write an application is reduced. With the use of WYSIWYG (What You See Is What You Get) editors, more people who do not have formal training or experience in coding computer programming languages can attempt to present themselves on mobile devices smart phones and tablet computers. This includes product managers and designers making between 60%-80% of the app before involving engineers.

Reduced Data Traffic—The system reduces the data queries to the internet as it stores the data locally on the mobile device itself, thereby making the application run faster.

1. A method and system to develop operating system agnostic software applications (or apps) for mobile devices like smart phones and tablet personal computers using an App Virtual Machine that interprets application definition during run-time.

2. A system of claim 1, where an operating system agnostic application definition language is defined that can:
Define the user interface (UI) comprising of one or more screens and each screen comprising of one or more controls.
Associate data sources to populate the UI with data
Associate actions with the events including but not limited to user gestures like tap, flick.
And attach business logic to validate, transform data or drive mobile app UI navigation.

3. A system of claim 1, where an App Virtual Machine is created that can interpret the operating system agnostic application definition at run time and call native Application Programming Interfaces (APIs) of the operating system to do following tasks:
Create the UI elements like screen and controls on the mobile device.
Populate the UI elements with data obtained from the data sources.
Invoke actions when events occur.
Each mobile device operating system will have its own implementation of the virtual machine.

4. A system of claim 1, where an action system is defined that consists of the most common tasks that an application running on mobile devices would need. Examples of actions include but not limited to are “go to next screen”, “close a screen” or “get data from a remote server”.

5. A system of claim 1, where rich and complex controls are developed as standalone components that can be incorporated as libraries in the mobile app using the operating system agnostic application definition language. These standalone components are developed using native Application Programming Interface (APIs) of the underlying Operating System and are integrated in the mobile application's executable file.
